(19) United States
(12) Patent Application Publication
(10) Pub. No.: US 2025/0045894 A1
(43) Pub. Date: Feb. 6, 2025

(54) IMAGE QUALITY EVALUATION SYSTEM, IMAGE QUALITY EVALUATION METHOD AND IMAGE CALIBRATION DEVICE

(71) Applicant: WISTRON NEWEB CORPORATION, HSINCHU (TW)

(72) Inventors: CHENG-YUAN CHANG, HSINCHU (TW); SHAU-SHENG LO, HSINCHU (TW); GUAN-WEN LIN, HSINCHU (TW); PO-CHING WU, HSINCHU (TW)

(21) Appl. No.: 18/776,333

(22) Filed: Jul. 18, 2024

(30) Foreign Application Priority Data
Aug. 4, 2023 (TW) 112129227

(51) Int. Cl. G06T 7/00; G06T 7/80; G06T 7/90; G06V 10/60

(52) U.S. Cl. CPC G06T 7/0002; G06T 7/80; G06T 7/90; G06V 10/60; G06T 2207/10024; G06T 2207/30168

(57) ABSTRACT

An image quality evaluation system includes an image calibration device, an image capturing device, and a processing device. The image calibration device is placed in a scene and used for displaying a calibration pattern. The capturing device captures a first comparison image of the scene and the calibration pattern. The processing device is configured to obtain the first comparison image and a reference image containing the calibration pattern and compare the calibration pattern in the first comparison image and the reference image to generate calibration information. After being calibrated according to the calibration information, the image capturing device captures a second comparison image of the scene and the calibration pattern, and the processing device compares the calibration pattern in the second comparison image and the reference image to generate an image quality evaluation result.

### CROSS-REFERENCE TO RELATED PATENT APPLICATION

This application claims the benefit of priority to Taiwan Patent Application No. 112129227, filed on Aug. 4, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a system, a method, and a device for processing images, and more particularly to an image quality evaluation system, an image quality evaluation method, and an image calibration device.

### BACKGROUND OF THE DISCLOSURE

In order to accurately assess the quality of images captured by image capturing devices, scenes are often set up with complex environmental background. For example, various colorful dolls, portraits, and objects are placed in the background of the scene, and then the image capturing device is set up to photograph the scene with environmental background.

Generally, the quality evaluation items for images captured by image capturing devices usually include clarity, contrast, saturation, brightness, noise level, and white balance. In the past, the quality assessment of images mostly relied on experienced experts. However, the training time for experts is long, and they may also provide subjective evaluations of image quality based on personal preferences.

### SUMMARY OF THE DISCLOSURE

In response to the above-referenced technical inadequacies, the present disclosure provides an image quality evaluation system, an image quality assessment method, and an image calibration device.

In order to solve the above-mentioned problems, one of the technical aspects adopted by the present disclosure is to provide an image quality evaluation system. The image quality evaluation system includes an image calibration device, an image capturing device, and a processing device. The image calibration device is placed in a scene and is used for displaying a calibration pattern. The image capturing device takes a shot of the scene and the calibration pattern to capture a first comparison image. The processing device is configured to obtain the first comparison image and a reference image containing the calibration pattern, compare the calibration pattern in the first comparison image and the reference image to generate a comparison result, and generate calibration information based on the comparison result. The image capturing device is then calibrated according to the calibration information, and the calibrated image capturing device takes another shot of the scene and the calibration pattern to capture a second comparison image. The processing device is configured to compare the calibration pattern in the second comparison image and the reference image to generate an image quality evaluation result.

In order to solve the above-mentioned problems, another one of the technical aspects adopted by the present disclosure is to provide an image quality evaluation method. The image quality evaluation method includes: capturing, by an image capturing device, a first comparison image of a scene and a calibration pattern displayed by an image calibration device; comparing, by a processing device configured to obtain the first comparison image and a reference image containing the calibration pattern, the calibration pattern in the first comparison image and the reference image to generate a comparison result, and generating calibration information based on the comparison result, wherein the image capturing device is calibrated according to the calibration information; capturing, by the calibrated image capturing device, a second comparison image of the scene and the calibration pattern; and comparing, by the processing device, the calibration pattern in the second comparison image and the reference image to generate an image quality evaluation result.

In order to solve the above-mentioned problems, yet another one of the technical aspects adopted by the present disclosure is to provide an image calibration device. The image calibration device includes a calibration pattern made of a background block, an analysis block, and a positioning block. The analysis block and the background block provide image quality information, and the positioning block provides positioning information and differs from the analysis block.

Therefore, in the image quality evaluation system, the image quality evaluation method, and the image calibration device provided by the present disclosure, precise position calibration and quantified image quality assessment can be achieved on an image taken by the image capturing device in a complex scene. Hence, the image quality assessment can be objective, and the development time for camera can be shortened.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of an image quality evaluation system according to one embodiment of the present disclosure;

FIG. 2 is a schematic diagram illustrating a positional arrangement of an image calibration device, a reference image capturing device, and a processing device in FIG. 1;

FIG. 3 is a schematic diagram illustrating a positional arrangement of an image calibration device, an image capturing device, and a processing device in FIG. 1;

FIG. 4 is a schematic diagram of an image calibration device according to one embodiment of the present disclosure;

FIG. 5 is a flowchart of an image quality evaluation method according to one embodiment of the present disclosure;

FIG. 6 is a schematic diagram illustrating how center translation is determined for calibration information;

FIG. 7 is a schematic diagram illustrating how rotation is determined for calibration information;

FIG. 8 is a schematic diagram illustrating how scaling is determined for calibration information;

FIG. 9 is a schematic diagram illustrating how camera tilt is determined for calibration information;

FIG. 10 is a flowchart of clarity quantitative evaluation according to one embodiment of the present disclosure;

FIG. 11 is a flowchart of white balance quantitative evaluation according to one embodiment of the present disclosure;

FIG. 12 is a flowchart of contrast quantitative evaluation according to one embodiment of the present disclosure;

FIG. 13 is a flowchart of saturation quantitative evaluation according to one embodiment of the present disclosure;

FIG. 14 is a flowchart of brightness quantitative evaluation according to one embodiment of the present disclosure;

FIG. 15 is a flow chart of a noise level quantitative evaluation according to one embodiment of the present disclosure; and

FIG. 16 is a radar chart illustrating image quality quantitative evaluation of two cameras.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles may be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like. In addition, the term “connect” in the context of the present disclosure means that there is a physical connection between two elements, and the two elements are directly or indirectly connected.

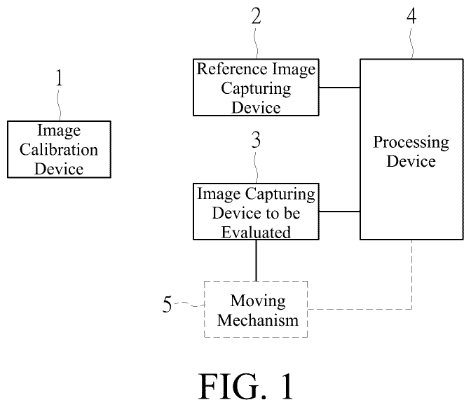

FIG. 1 is a functional block diagram of an image quality evaluation system according to one embodiment of the present disclosure. Referring to FIG. 1, the image quality evaluation system includes an image calibration device 1, a reference image capturing device 2, an image capturing device 3, and a processing device 4. The image capturing device 3 is, for example, an image capturing device to be evaluated. The reference image capturing device 2 and the image capturing device 3 are configured to take photographs or capture images of the image calibration device 1 and are electrically connected to the processing device 4 at different time points.

As an example, the image calibration device 1 is a polygonal board; the image capturing devices 2 and 3 are single lens reflex cameras (SLR), twin lens reflex cameras (TLR), or depth cameras; and the processing device 4 is a personal computer, a server, or a mobile terminal, but the present disclosure is not limited thereby.

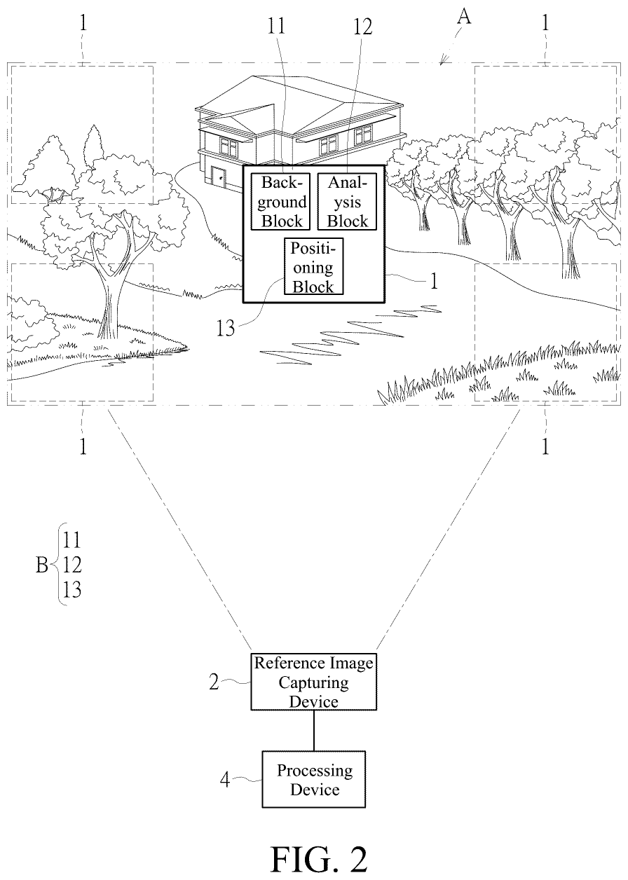

FIG. 2 is a schematic diagram illustrating a positional arrangement of the image calibration device, the reference image capturing device, and the processing device in FIG. 1. Referring to FIG. 2, located approximately at the center of a scene A, the image calibration device 1 is a quadrilateral board with a calibration pattern B on its surface. The calibration pattern B consists a background block 11, an analysis block 12, and a positioning block 13. The background block 11 and the analysis block 12 are used to provide image quality information such as clarity, white balance, contrast, saturation, brightness, and noise level. The positioning block 13 is used to provide positioning information such as center coordinate and area, and at least one of the color, shape, and pattern of the positioning block 13 differs from that of the analysis block 12.

The reference image capturing device 2 is positioned a distance from the scene A and the image calibration device 1, with its lens facing the scene A. The reference image capturing device 2 is configured to capture the scene A and the calibration pattern B to obtain a reference image, which includes the scene A, the image calibration device 1 and the calibration pattern B displayed on the image calibration device 1. The processing device 4 is configured to acquire the reference image. It is to be noted that the reference image capturing device 2 has been calibrated, and the quality of the reference image it captures meets specific evaluation items (i.e. clarity, contrast, saturation, brightness, white balance, and noise level), making the reference image a benchmark for image quality evaluation.

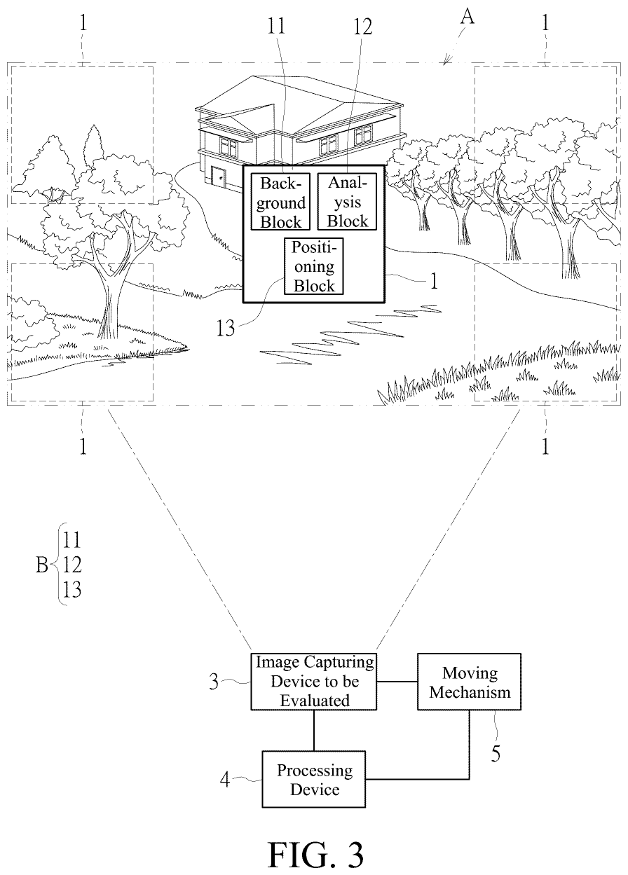

FIG. 3 is a schematic diagram illustrating a positional arrangement of an image calibration device, an image capturing device, and a processing device in FIG. 1. Referring to FIG. 3, the image calibration device 1 is a quadrilateral board and is approximately located at the center of the scene A, and the position, aperture setting, and shutter setting of the image capturing device 3 are the same as those of the reference image capturing device 2. The image quality of the image taken by the image capturing device 3 may be different from the image quality of the image taken by the reference image capturing device 2, and thus an image quality evaluation is required to determine whether the image capturing device 3 needs calibration.

The lens of the image capturing device 3 faces toward the scene A and is configured to take a shot of the scene A and the calibration pattern B to capture a first comparison image. The first comparison image includes the scene A, the image calibration device 1, and the calibration pattern B displayed on the image calibration device 1. The processing device 4 is configured to obtain the first comparison image and the reference image.

The calibration pattern B is composed of the background block 11, the analysis block 12, and the positioning block 13. The analysis block 12 is located approximately at the center of the calibration pattern B and includes at least three different patterns. The positioning block 13 is located approximately at the periphery of the calibration pattern B, and the color in the positioning block 13 is different from the color in the background block 11. Through the design of the calibration pattern B, the processing device 4 is able to compare the positioning block 13 of the calibration pattern B in the first comparison image and the positioning block 13 of the calibration pattern B in the reference image to generate a comparison result and further generate calibration information based on the comparison result. The calibration information includes center translation, rotation, scaling, and camera tilt. Thus, a user can manually adjust the position of the image capturing device 3 according to the calibration information provided by the processing device 4.

After the position calibration of the image capturing device 3, the calibrated image capturing device 3 takes another shot of the scene A and the calibration pattern B to capture a second comparison image, and the processing device 4 is configured to obtain the second comparison image.

After obtaining the second comparison image, the processing device 4 compares the calibration pattern B in the second comparison image and the calibration pattern B in the reference image to generate the image quality evaluation result of the second comparison image.

Optionally, the image quality evaluation system further includes a moving mechanism 5 connected to the image capturing device 3. The moving mechanism 5 includes a moving part, a rotating part and any combination thereof. The processing device 4 controls the moving mechanism 5 according to the calibration information to change the direction and position of the image capturing device 3. In other words, the moving mechanism 5 performs the position calibration of the image capturing device 3, which in turn automates the calibration operation with higher precision than manual operation.

Optionally, the number of image calibration device 1 is plural. For example, there are five image calibration devices 1 located respectively at the center and four corners of the scene A. As such, the precision for position calibration and image quality evaluation is enhanced.

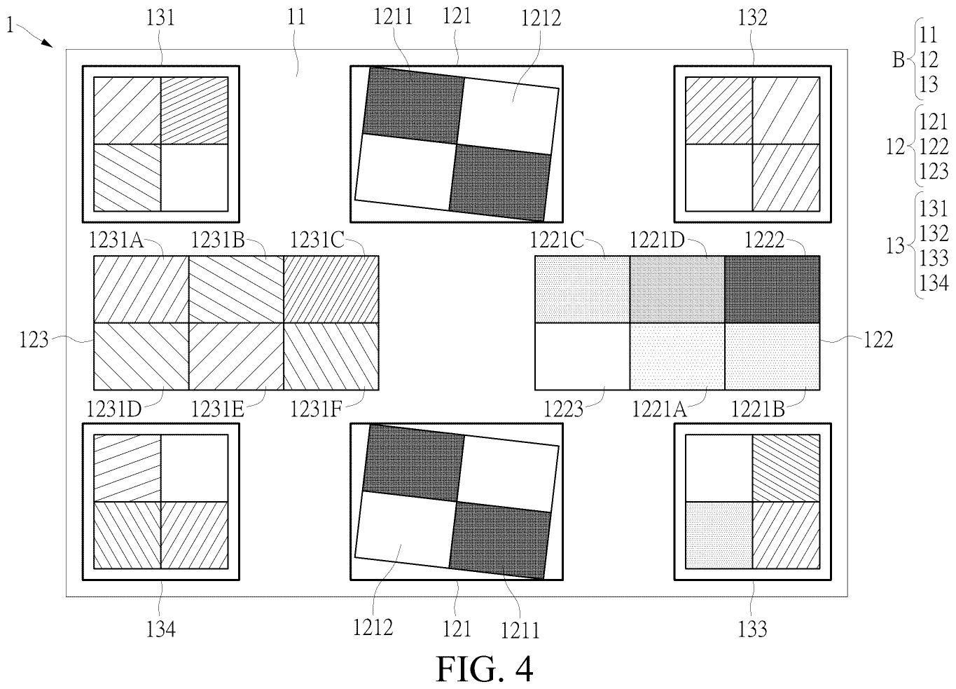

FIG. 4 is a schematic diagram of an image calibration device according to one embodiment of the present disclosure. Referring to FIG. 4, the analysis block 12 is located approximately at the center of the calibration pattern B, and any color displayed in the analysis block 12 differs from the color displayed in the background block 11. The analysis block 12 contains at least three different patterns, where the term “different patterns” refers to variations in at least one of color and shape.

The analysis block 12 includes a first sub-analysis block 121, a second sub-analysis block 122, and a third sub-analysis block 123. The first sub-analysis block 121, the second sub-analysis block 122, and the third sub-analysis block 123 differ from each other in at least one of color and shape.

The first sub-analysis block 121 has an inclined angle and includes a pair of first color blocks 1211 and a pair of second color blocks 1212, which are complementary colors. The first color blocks 1211 and the second color blocks 1212 are quadrilateral. The inclined edges in the first sub-analysis block 121 creates varying levels of clarity; the alternating sections of the first color blocks 1211 and the second color blocks 1212 produce a frequency of jagged edges, allowing the clarity of the first sub-analysis block 121 to be calculated. The second sub-analysis block 122 includes multiple third color blocks 1221A, 1221B, 1221C, 1221D with different grayscale levels, and a fourth color block 1222 and a fifth color block 1223, which complement each other in color. The third sub-analysis block 123 includes multiple sixth color blocks 1231A, 1231B, 1231C, 1231D, 1231E, 1231F with at least six different colors.

The first color blocks and second color blocks in the first sub-analysis block 121 are quadrilateral, with the colors being black and white, respectively. The third color blocks, fourth color blocks, and fifth color blocks in the second sub-analysis block 122 are quadrilateral, with the third color blocks having various shades of gray, and the fourth and fifth color blocks being black and white, respectively. The sixth color blocks in the third sub-analysis block 123 are quadrilateral, with colors including pink, blue, purple, green, yellow, and orange.

Optionally, the first and second color blocks can be circular, triangular, or other polygons, with the colors being red and green, or yellow and purple. The fourth and fifth color blocks can also be circular, triangular, or other polygons, with the colors being red and green, or yellow and purple. The number of sixth color blocks can be more than six, with more than six colors.

Through the design of the analysis block 12 in FIG. 4, complex scene image comparisons can be achieved.

The positioning block 13 is located around the calibration pattern B, and any color displayed in the positioning block 13 differs from the color displayed in the background block 11. The positioning block 13 includes a first sub-positioning block 131, a second sub-positioning block 132, a third sub-positioning block 133, and a fourth sub-positioning block 134. The first sub-positioning block 131, the second sub-positioning block 132, the third sub-position-positioning block 133, and the fourth sub-positioning block 134 are respectively located at the top left, top right, bottom right, and bottom left corners of the calibration pattern B, surrounding the analysis block 12. In this embodiment, the calibration pattern B, the first sub-positioning block 131, the second sub-positioning block 132, the third sub-positioning block 133, and the fourth sub-positioning block 134 are rectangular areas, but the present disclosure is not limited to this configuration.

Each of the first sub-positioning block 131, the second sub-positioning block 132, the third sub-positioning block 133, and the fourth sub-positioning block 134 includes multiple color blocks of different colors. The color of any color block in the first sub-positioning block 131, the second sub-positioning block 132, the third sub-positioning block 133, and the fourth sub-positioning block 134 differs from the color of the background block 11, and the arrangement of color blocks in the first sub-positioning block 131, the second sub-positioning block 132, the third sub-positioning block 133, and the fourth sub-positioning block 134 does not repeat.

Specifically, the first sub-positioning block 131 is located at the top left corner of the calibration pattern B. The upper half of the first sub-positioning block 131 has two color blocks from left to right with a first color and a second color, respectively, while the lower half has two color blocks from left to right with a third color and a fourth color, respectively.

The second sub-positioning block 132 is located at the top right corner of the calibration pattern B. The upper half of the second sub-positioning block 132 has two color blocks from left to right with the second color and the first color, respectively, while the lower half has two color blocks from left to right with the fourth color and the third color, respectively.

The third sub-positioning block 133 is located at the bottom right corner of the calibration pattern B. The upper half of the third sub-positioning block 133 has two color blocks from left to right with the fourth color and the third color, respectively, while the lower half has two color blocks from left to right with the first color and the second color, respectively.

The fourth sub-positioning block 134 is located at the bottom left corner of the calibration pattern B. The upper half of the fourth sub-positioning block 134 has two color blocks from left to right with the third color and the fourth color, respectively, while the lower half has two color blocks from left to right with the second color and the first color, respectively.

The first color, second color, third color, and fourth color may be red, green, blue, and black, respectively, but the present disclosure is not limited to these colors as long as they differ from the color of the background block 11.

Through the design of the positioning block 13 in FIG. 4, complex scene image positioning can be achieved.

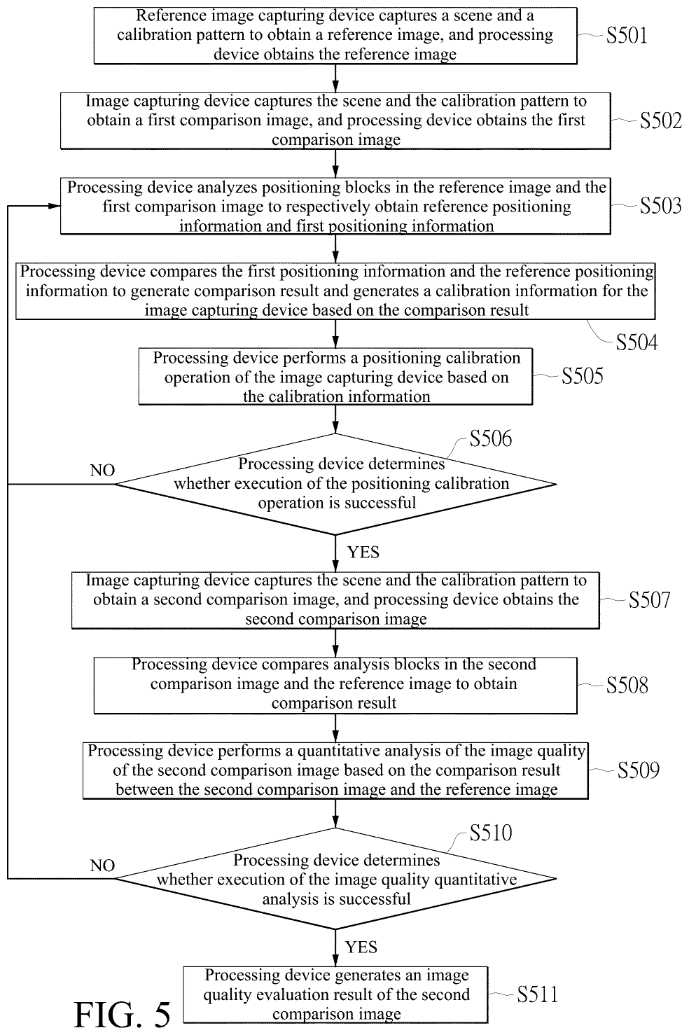

FIG. 5 is a flowchart of an image quality evaluation method according to one embodiment of the present disclosure, which is suitable for the image calibration device 1 of FIG. 4. Referring to FIG. 5, in step S501, the reference image capturing device 2 takes a photograph of the scene A and the calibration pattern B to capture a reference image, and the processing device 4 is configured to obtain the reference image. In step S502, the image capturing device 3 to be evaluated takes a photograph of the scene A and the calibration pattern B to capture a first comparison image, and the processing device 4 is configured to obtain the first comparison image.

In step S503, the processing device 4 is configured to analyze the positioning blocks 13 in the reference image and the first comparison image to obtain reference positioning information and first positioning information, respectively. Specifically, the processing device 4 performs binarization processing on the reference image and the first comparison image to obtain the contours of the positioning blocks 13 in the reference image and the first comparison image.

In step S504, the processing device 4 is configured to compare the first positioning information with the reference positioning information to generate a comparison result, and based on the comparison result, generate calibration information for the image capturing device 3 to be evaluated.

In step S505, the processing device 4 is configured to perform a positioning calibration operation of the image capturing device 3 to be evaluated based on the calibration information. Specifically, the positioning calibration operation of the image capturing device 3 to be evaluated is performed by the moving mechanism 5.

In step S506, the processing device 4 is configured to determine whether the execution of the positioning calibration operation is successful. If successful, proceed to step S507. If not, return to step S503. Specifically, the success of the positioning calibration operation is determined by a user-defined acceptable error range. If the distance difference between the center position of the calibration pattern in the calibrated first comparison image and the center position of the calibration pattern in the reference image is within the acceptable error range, the positioning calibration operation is considered successful; otherwise, it is considered a failure.

In step S507, the image capturing device 3 to be evaluated takes a photograph of the scene A and the calibration pattern B again to capture a second comparison image, and the processing device 4 is configured to obtain the second comparison image.

In step S508, the processing device 4 is configured to compare the analysis blocks 12 in the second comparison image and the reference image to obtain the comparison result.

In step S509, the processing device 4 is configured to perform a quantitative analysis of the image quality of the second comparison image based on the comparison result between the second comparison image and the reference image.

In step S510, the processing device 4 is configured to determine whether the execution of the image quality quantitative analysis is successful. If successful, proceed to step S511. If not, return to step S503. Specifically, the success of the image quality quantitative analysis is determined by a user-defined evaluation score threshold. When the evaluation score is greater than or equal to the evaluation score threshold, the execution of the image quality quantitative analysis is considered successful; otherwise, it is considered a failure.

In step S511, the processing device 4 is configured to generate an image quality evaluation result of the second comparison image.

Through the image quality evaluation method shown in FIG. 5, even in complex scenes, precise positioning calibration operations can be performed on the image capturing device 3 to be evaluated, and the image quality of the images captured by the image capturing device 3 to be evaluated can be accurately quantified and scored.

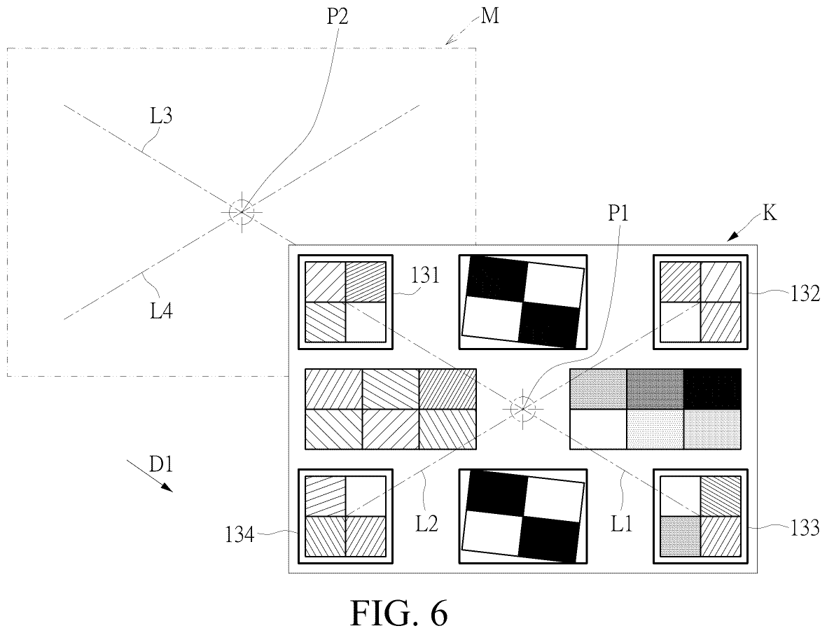

FIG. 6 is a schematic diagram illustrating how the processing device 4 determines center translation for calibration information. As shown in FIG. 6, the intersection of a first straight line L1 and a second straight line L2 is the first center point P1 of the calibration pattern B in the reference image K, while the intersection of a third straight line L3 and a fourth straight line L4 is the second center point P2 of the calibration pattern B in the first comparison image M. The processing device 4 obtains the coordinates of the first center point P1 and the second center point P2 and calculates the center translation between the first center point P1 and the second center point P2, providing the center translation calibration information, which includes the distance and direction information/prompts D1 for moving the image capturing device 3 to be evaluated.

Specifically, the processing device 4 performs binarization processing on the reference image K and the first comparison image M to identify the contours of the rectangular objects in the reference image K and the first comparison image M. Then, the processing device 4 determines whether each rectangular object contains the defined four colors of color blocks. If so, the rectangular object is marked as a sub-positioning block. In this way, the processing device 4 marks the first sub-positioning block 131, the second sub-positioning block 132, the third sub-positioning block 133, and the fourth sub-positioning block 134 in the reference image K and the first comparison image M, and identifies the positioning center points of each sub-positioning block. The first straight line L1 and the second straight line L2 are defined by the four positioning center points in the reference image K, while the third straight line L3 and the fourth straight line L4 are defined by the four positioning center points in the first comparison image M.

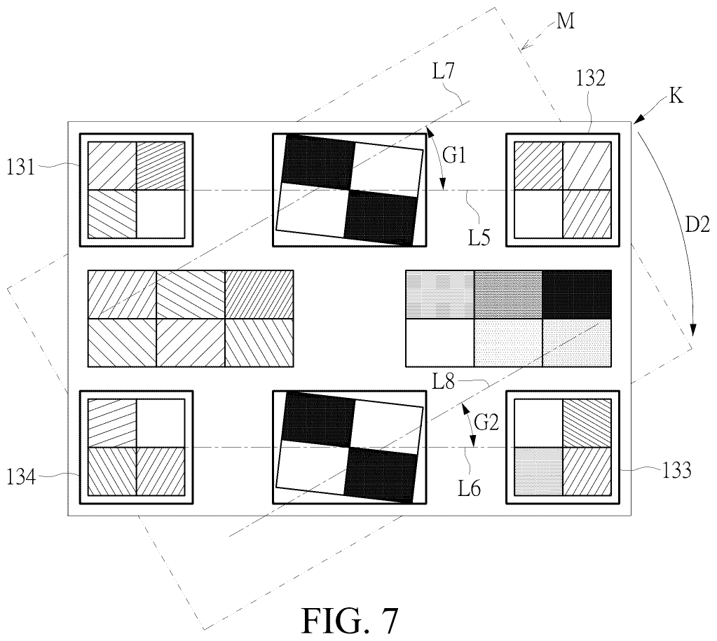

FIG. 7 is a schematic diagram illustrating how the processing device 4 determines rotation for calibration information. As shown in FIG. 7, a fifth straight line L5 and a sixth straight line L6 in the reference image K are parallel to each other, while a seventh straight line L7 and an eighth straight line L8 in the first comparison image M are parallel to each other. The intersection of the fifth straight line L5 and the seventh straight line L7 forms a first angle G1, and the intersection of the sixth straight line L6 and the eighth straight line L8 forms a second angle G2. The processing device 4 calculates the average value of the first angle G1 and the second angle G2 and defines it as the rotation (angle) of the calibration pattern B in the first comparison image M relative to the calibration pattern B in the reference image K. Ideally, the first angle G1 should be equal to the second angle G2, but in practice, there may be slight differences between the first angle G1 and the second angle G2. Therefore, the average value of the first angle G1 and the second angle G2 is defined as the rotation angle. Finally, the processing device 4 provides the rotation calibration information, which includes the rotation angle information/prompt and the rotation direction information/prompt D2 for moving the image capturing device 3 to be evaluated.

Specifically, the fifth straight line L5 and the sixth straight line L6 are defined by the four positioning center points in the reference image K, while the seventh straight line L7 and the eighth straight line L8 are defined by the four positioning center points in the first comparison image M.

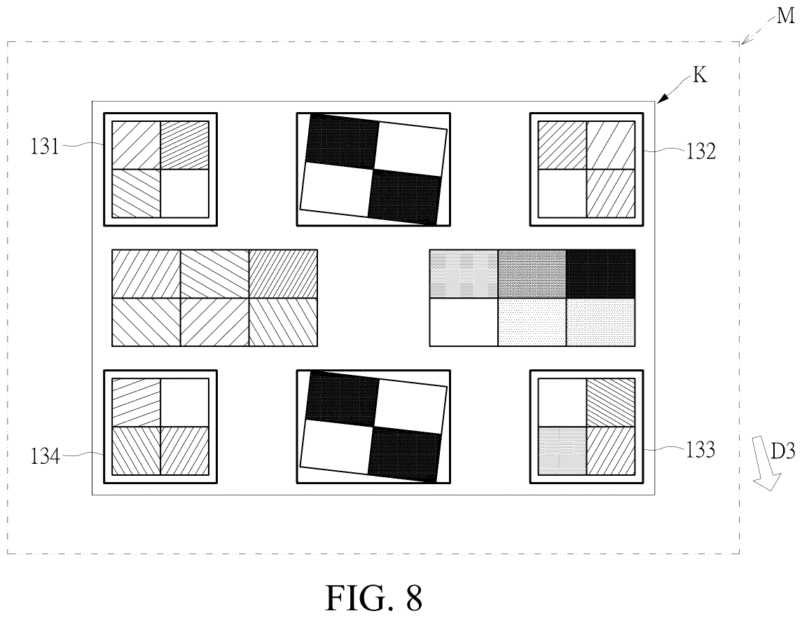

FIG. 8 is a schematic diagram illustrating how the processing device 4 determines scaling for calibration information. As shown in FIG. 8, the processing device 4 obtains the areas of the first sub-positioning block 131, the second sub-positioning block 132, the third sub-positioning block 133, and the fourth sub-positioning block 134 in the reference image K and the first comparison image M, respectively. The processing device 4 sums the areas of the first sub-positioning block 131, the second sub-positioning block 132, the third sub-positioning block 133, and the fourth sub-positioning block 134 in the reference image K and calculates their average to generate a first average area. The processing device 4 sums the areas of the first sub-positioning block 131, the second sub-positioning block 132, the third sub-positioning block 133, and the fourth sub-positioning block 134 in the first comparison image M and calculates their average to generate a second average area. The processing device 4 calculates the ratio of the second average area to the first average area to obtain the scaling factor, and provides the scaling calibration information, which includes the direction information/prompt D3 for moving the image capturing device 3 to be evaluated.

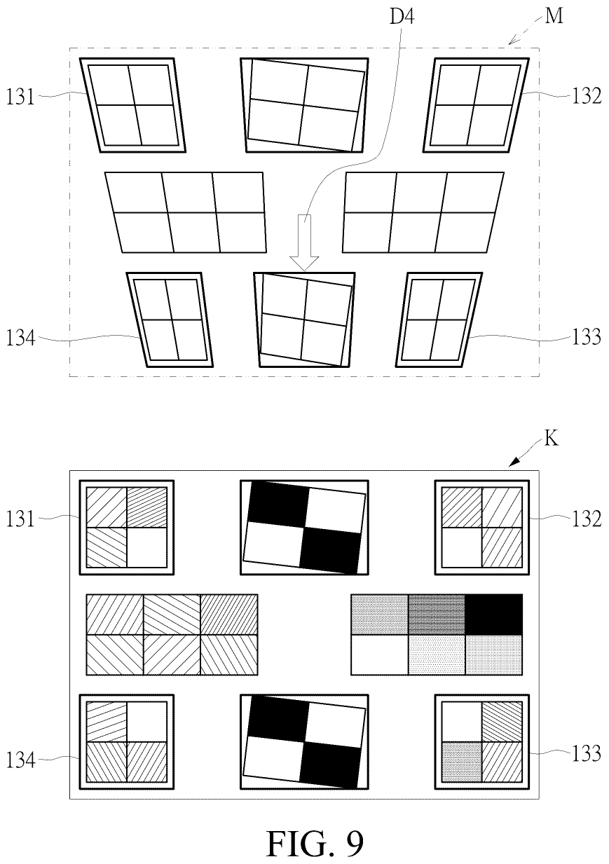

FIG. 9 is a schematic diagram illustrating how the processing device 4 determines camera tilt for calibration information. As shown in FIG. 9, the processing device 4 calculates the area ratios of the first sub-positioning block 131, the second sub-positioning block 132, the third sub-positioning block 133, and the fourth sub-positioning block 134 in the reference image K and the first comparison image M, respectively, to obtain the camera tilt, and provides the camera tilt calibration information, which includes the tilt direction information/prompt D4 for moving the image capturing device 3 to be evaluated.

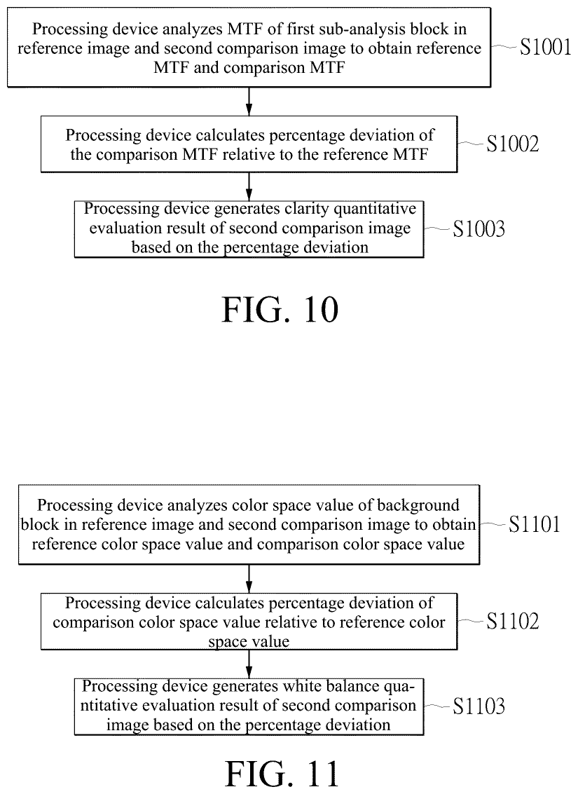

FIG. 10 is a flowchart of clarity quantitative evaluation performed by the processing device 4. Referring to FIGS. 4 and 10, in step S1001, the processing device 4 is configured to analyze the Modulation Transfer Function (MTF) of the first sub-analysis block in the reference image and the second comparison image, respectively, to obtain the reference MTF and the comparison MTF. In step S1002, the processing device 4 is configured to calculate the percentage deviation of the comparison MTF relative to the reference MTF. In step S1003, the processing device 4 generates the clarity quantitative evaluation result of the second comparison image based on the percentage deviation.

For example, when the percentage deviation of the comparison MTF relative to the reference MTF is less than 5%, the clarity quantitative score of the second comparison image ranges from 7 to 10. When the percentage deviation of the comparison MTF relative to the reference MTF is between 5% and 10%, the clarity quantitative score of the second comparison image ranges from 4 to 6. When the percentage deviation of the comparison MTF relative to the reference MTF is between 10% and 15%, the clarity quantitative score of the second comparison image ranges from 1 to 3. When the percentage deviation of the comparison MTF relative to the reference MTF exceeds 15%, the clarity quantitative score of the second comparison image is 0.

FIG. 11 is a flowchart of white balance quantitative evaluation performed by the processing device 4. Referring to FIGS. 4 and 11, in step S1101, the processing device 4 is configured to analyze the color space value of the background block in the reference image and the second comparison image, respectively, to obtain the reference color space value and the comparison color space value. Specifically, the color space values may be CIELAB color space values or CIELCH color space values. In step S1102, the processing device 4 is configured to calculate the percentage deviation of the comparison color space value relative to the reference color space value. In step S1103, the processing device 4 generates the white balance quantitative evaluation result of the second comparison image based on the percentage deviation.

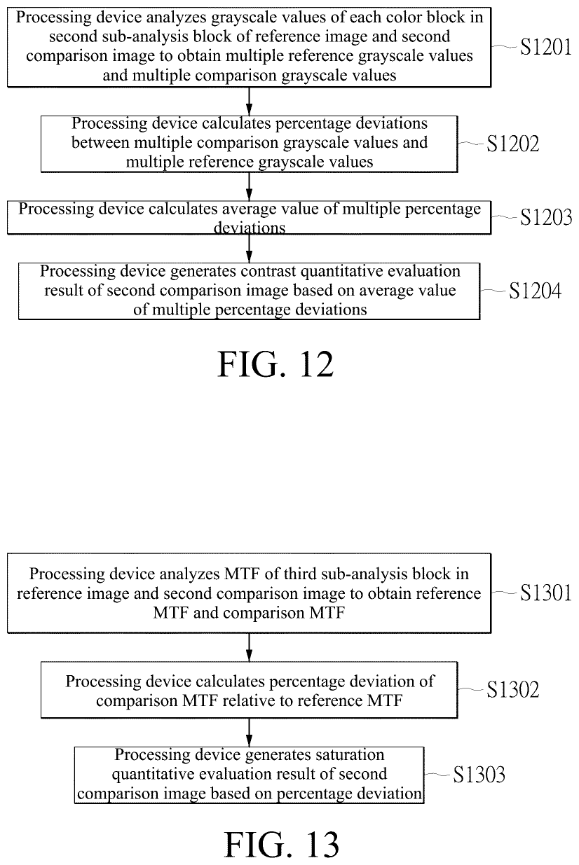

FIG. 12 is a flowchart of contrast quantitative evaluation performed by the processing device 4. Referring to FIGS. 4 and 12, in step S1201, the processing device 4 is configured to analyze the grayscale values of each color block in the second sub-analysis block of the reference image and the second comparison image, respectively, to obtain multiple reference grayscale values and multiple comparison grayscale values. In step S1202, the processing device 4 calculates the percentage deviations between the multiple comparison grayscale values and the multiple reference grayscale values. In step S1203, the processing device 4 calculates the average value of the multiple percentage deviations. In step S1204, the processing device 4 generates the contrast quantitative evaluation result of the second comparison image based on the average value of the multiple percentage deviations.

FIG. 13 is a flowchart of a method for saturation quantitative evaluation performed by the processing device 4. Referring to FIGS. 4 and 13, in step S1301, the processing device 4 is configured to analyze the Modulation Transfer Function (MTF) of the third sub-analysis block in the reference image and the second comparison image, respectively, to obtain the reference MTF and the comparison MTF. In step S1302, the processing device 4 calculates the percentage deviation of the comparison MTF relative to the reference MTF. In step S1303, the processing device 4 generates the saturation quantitative evaluation result of the second comparison image based on the percentage deviation.

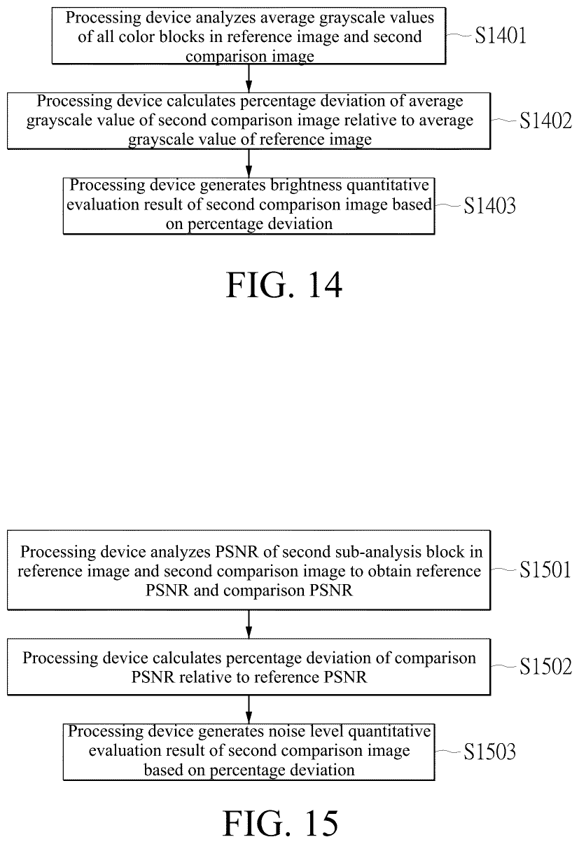

FIG. 14 is a flowchart of brightness quantitative evaluation performed by the processing device 4. Referring to FIGS. 4 and 14, in step S1401, the processing device 4 is configured to analyze the average grayscale values of all color blocks in the reference image and the second comparison image. In step S1402, the processing device 4 calculates the percentage deviation of the average grayscale value of the second comparison image relative to the average grayscale value of the reference image. In step S1403, the processing device 4 generates the brightness quantitative evaluation result of the second comparison image based on the percentage deviation.

FIG. 15 is a flowchart of noise level quantitative evaluation performed by the processing device 4. Referring to FIGS. 4 and 15, in step S1501, the processing device 4 is configured to analyze the Peak Signal-to-Noise Ratio (PSNR) of the second sub-analysis block in the reference image and the second comparison image, respectively, to obtain the reference PSNR and the comparison PSNR. In step S1502, the processing device 4 calculates the percentage deviation of the comparison PSNR relative to the reference PSNR. In step S1503, the processing device 4 generates the noise level quantitative evaluation result of the second comparison image based on the percentage deviation.

Through the quantitative analysis methods for the six image quality items shown in FIGS. 10 to 15, the processing device 4 can obtain the quantitative scores of the six image quality items for the images captured by the image capturing device 3 to be evaluated. Finally, the processing device 4 can create a radar chart based on these quantitative scores to display the evaluation results of clarity, white balance, contrast, saturation, brightness, and noise level. Since each image quality item can be quantitatively evaluated, users can easily determine whether the image quality of images captured by cameras with different specifications is comparable, making the evaluation of image quality more objective and addressing the issue of long camera development cycles.

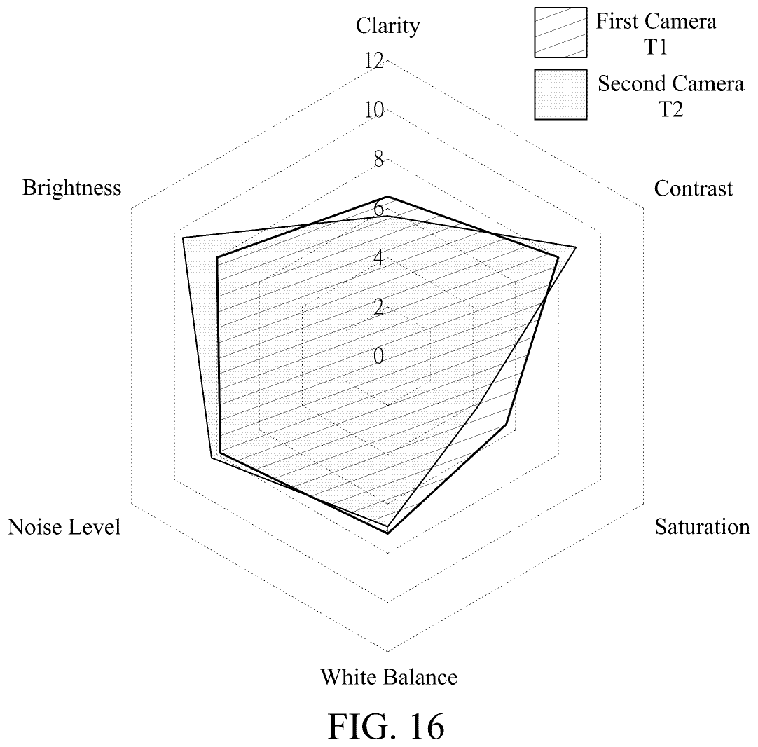

FIG. 16 is a radar chart showing the quantitative evaluation of image quality for two different cameras. As shown in FIG. 16, the image quality evaluation items include clarity, white balance, contrast, saturation, brightness, and noise level. The clarity score of the first camera T1 is higher than that of the second camera T2. The white balance score of the first camera T1 is higher than that of the second camera T2. The contrast score of the first camera T1 is lower than that of the second camera T2. The saturation score of the first camera T1 is higher than that of the second camera T2. The brightness score of the first camera T1 is lower than that of the second camera T2. The noise level score of the first camera T1 is lower than that of the second camera T2.

### Beneficial Effects of the Embodiments

In conclusion, the image quality evaluation system, image quality evaluation method, and image calibration device provided by the present disclosure can perform precise positioning calibration operations on the images captured by the image capturing devices in complex scenes and generate quantitative evaluation scores for the image quality. This makes the evaluation of image quality more objective and helps resolve the issue of long camera development cycles.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An image quality evaluation system, comprising:
an image calibration device placed in a scene for displaying a calibration pattern;
an image capturing device for capturing a first comparison image of the scene and the calibration pattern; and
a processing device configured to obtain the first comparison image and a reference image containing the calibration pattern, compare the calibration pattern in the first comparison image and the reference image to generate a comparison result, and generate calibration information based on the comparison result;
wherein the image capturing device is calibrated according to the calibration information, the calibrated image capturing device captures a second comparison image of the scene and the calibration pattern, and the processing device compares the calibration pattern in the second comparison image and the reference image to generate an image quality evaluation result.

2. The image quality evaluation system according to claim 1, wherein the calibration pattern comprises a positioning block, and the processing device is configured to:
analyze the positioning block in the first comparison image to obtain first positioning information;
analyze the positioning block in the reference image to obtain reference positioning information; and
compare the first positioning information and the reference positioning information to obtain the calibration information.

3. The image quality evaluation system according to claim 2, wherein the processing device controls a moving mechanism connected to the image capturing device according to the calibration information to adjust a direction and a position of the image capturing device, and the calibration information comprises center translation, rotation, scaling, and camera tilt.

4. The image quality evaluation system according to claim 1, wherein the calibration pattern comprises an analysis block, and the processing device compares the analysis block in the second comparison image and the reference image to generate the image quality evaluation result.

5. The image quality evaluation system according to claim 1, wherein the image quality evaluation result comprises a clarity evaluation result, a white balance evaluation result, a contrast evaluation result, a saturation evaluation result, a brightness evaluation result, and a noise level evaluation result.

6. The image quality evaluation system according to claim 1, further comprising a total of five image calibration devices located respectively at four corners and a center of the scene.

7. An image quality evaluation method, comprising:
capturing, by an image capturing device, a first comparison image of a scene and a calibration pattern displayed by an image calibration device placed in the scene;
comparing, by a processing device configured to obtain the first comparison image and a reference image containing the calibration pattern, the calibration pattern in the first comparison image and the reference image to generate a comparison result, and generating calibration information based on the comparison result, wherein the calibration information is used to calibrate the image capturing device;
capturing, by the calibrated image capturing device, a second comparison image of the scene and the calibration pattern; and
comparing, by the processing device, the calibration pattern in the second comparison image and the reference image to generate an image quality evaluation result.

8. The image quality evaluation method according to claim 7, wherein the calibration pattern comprises an analysis block, and the processing device compares the analysis block in the second comparison image and the reference image to generate the image quality evaluation result.

9. The image quality evaluation method according to claim 7, wherein the calibration pattern comprises an analysis block, and the processing device analyzes the analysis block in the second comparison image and the analysis block in the reference image to respectively obtain a modulation transfer function and a reference modulation transfer function, and based on a deviation percentage between the modulation transfer function and the reference modulation transfer function, generates a clarity evaluation result of the image quality evaluation result.

10. The image quality evaluation method according to claim 7, wherein the calibration pattern comprises a background block, and the processing device analyzes the background block in the second comparison image and the background block in the reference image to obtain respectively a color space value and a reference color space value, and based on a deviation percentage between the color space value and the reference color space value, generates a white balance evaluation result of the image quality evaluation result.

11. The image quality evaluation method according to claim 7, wherein the calibration pattern comprises an analysis block, and the processing device analyzes the analysis block in the second comparison image and the analysis block in the reference image to obtain respectively a grayscale and a reference grayscale, and based on a deviation percentage between the gray scale and the reference grayscale, generates a contrast evaluation result of the image quality evaluation result.

12. The image quality evaluation method according to claim 7, wherein the calibration pattern comprises an analysis block, and the processing device analyzes the analysis block in the second comparison image and the analysis block in the reference image to obtain respectively a color space value and a reference space value, and based on the deviation percentage between the color space value and the reference color space value, generates a saturation evaluation result of the image quality evaluation result.

13. The image quality evaluation method according to claim 7, wherein the processing device analyzes the second comparison image and the reference image to obtain respectively an average grayscale and a reference average grayscale, and based on a deviation percentage between the average grayscale and the reference average grayscale, generates a brightness evaluation result of the image quality evaluation result.

14. The image quality evaluation method according to claim 7, wherein the calibration pattern comprises an analysis block, and the processing unit analyzes the analysis block in the second comparison image and the analysis block in the reference image to obtain respectively a peak signal-to-noise ratio and a reference peak signal-to-noise ratio, and based on a deviation percentage between the peak signal-to-noise ratio and the reference peak signal-to-noise ratio, generates a noise level evaluation result of the image quality evaluation result.

15. An image calibration device comprising:
a calibration pattern comprising a background block, an analysis block, and a positioning block;
wherein the analysis block and the background block provide image quality information, and the positioning block is different from the analysis block and provides positioning information.

16. The image calibration device according to claim 15, wherein the positioning block comprises at least one color, and a color of the background block is different from the at least one color of the positioning block.

17. The image calibration device according to claim 15, wherein the analysis block comprises at least three sub-analysis blocks that are different in color or pattern.

18. The image calibration device according to claim 15, wherein the positioning block comprises a plurality of sub-positioning blocks located respectively at a plurality of corners of the calibration pattern.

19. The image calibration device according to claim 18, wherein each of the plurality of sub-positioning blocks comprises a plurality of color blocks of different colors, and the plurality of color blocks in one of the plurality of sub-positioning blocks are arranged differently from the plurality of color blocks in another one of the plurality of sub-positioning blocks.

20. The image calibration device according to claim 15, wherein the analysis block comprises a first sub-analysis block, a second sub-analysis block, and a third sub-analysis block; the first sub-analysis block comprises a pair of first color blocks and a pair of second color blocks, and the two pairs are compliment to each other in color; the second sub-analysis block comprises a plurality of third color blocks with different grayscale, a fourth color block, and a fifth color block, and the fourth color block and the fifth color block are compliment to each other in color; and the third sub-analysis block comprises a plurality of sixth color blocks with at least six colors.
